(19) United States
(12) Patent Application Publication
(10) Pub. No.: US 2026/0123584 A1
(43) Pub. Date: May 7, 2026

(54) RECYCLABLE GARDENING SHEARS

(71) Applicant: JIIN HAUR INDUSTRIAL CO.,LTD., LU KANG TOWN (TW)

(72) Inventor: Shih-Piao Wu, LU KANG TOWN (TW)

(21) Appl. No.: 18/935,674

(22) Filed: Nov. 4, 2024

(51) Int. Cl. A01G 3/02

(52) U.S. Cl. CPC A01G 3/021

(57) ABSTRACT

Recyclable gardening shears include two handles and a gardening shear body. The handles are made of plastic, with at least one through hole disposed on each of the handles, a slit disposed on one side of each of the handles and extended to the top of the handle, and a pad made of the same material as the handles and coupled to the other side of the handle. The gardening shear body has two cutting elements, two legs, a resilient element, a safety device and a plurality of joining elements, made of metal each, with multiple penetrating holes disposed on each of the two cutting elements and each of the two legs. A buffering pad is fitted to one of the legs.

### FIELD

The present disclosure relates to recyclable gardening shears, and more particularly to a gardening shear structure that is easy to dismantle completely and recycle.

### BACKGROUND

Common, conventional gardening shears essentially comprise two blades. Each of the two blades is connected to a leg enclosed by a handle. A penetrating hole is disposed centrally in the blade and is penetrable by a screw. Then, the screw is fastened in place with a nut, allowing the two blades to be pivotally fitted together and positioned in place. When a force is applied to the two handles, the penetrating hole serves as a pivoting point to allow the blades to be opened and closed to perform a cutting process. Each of the two handles is covered with a soft pad in a close-fitting manner to ensure an easy grip. Since the blades, the legs, the screws and the nuts are made of metal, with the handles and the pads being made of nonmetal plastics that differ in hardness, recycling and reproducing the gardening shears necessitates separating the metallic blades, screws and nuts from the nonmetallic handles completely and peeling the pads off the handles.

However, the conventional gardening shears have drawbacks in terms of actual use as described below. The handles are made by integral injection in a manner to tightly enclose the legs. As a result, the handles will have a higher chance of being separated from metallic components, such as the legs, only after being deliberately damaged – a time-consuming, laborious process which incurs high recycling cost and thus discourages recycling dealers from recycling the conventional gardening shears. Since the conventional gardening shears cannot be effectively recycled and reproduced, the conventional gardening shears cannot keep pace with the global trend toward net-zero carbon emissions and thus are doomed to flagging sales, boycotts, and a weak competitive position.

As a result, there is still room for improvement in the prior art pertaining to the conventional gardening shears.

### SUMMARY

### Technical issue to address:

Conventional gardening shears comprise metallic components and nonmetallic components which are difficult to separate from the metallic components, adding to the difficulty in recycling and undermining recycling efficiency.

### Technical features of the solution to the technical issue:

The disclosure provides recyclable gardening shears, comprising: two handles; and a gardening shear body. The handles are made of plastic, with at least one through hole disposed on each of the handles, a slit disposed on one side of each of the handles and extended to the top of the handle, and a pad made of the same material as the handles and coupled to the other side of the handle. The gardening shear body has two cutting elements, two legs, a resilient element, a safety device and a plurality of joining elements, made of metal each, with multiple penetrating holes disposed on each of the two cutting elements and each of the two legs, the slits of the two handles engage with the two legs respectively, and the joining elements are penetratingly disposed in the through holes and the penetrating holes respectively, allowing the handles to be coupled to the legs, connecting the two cutting elements pivotally, and connecting the legs to the cutting elements. The safety device is mounted on the handles and the gardening shear body, using the joining elements. The resilient element fits snugly between the two handles. A buffering pad is fitted to one of the legs and protrudes from the corresponding one of the handles.

### Advantages of the disclosure over the prior art:

First, the disclosure provides recyclable gardening shears. To recycle the gardening shears, a user only needs to peel the pads off the handles, detach the joining elements and disengage the legs from the slits, separating the handles, the pads, the cutting elements, the legs, the resilient element, the safety device, the joining elements and the buffering pads. The gardening shears of the disclosure dispenses with a damaging means and is still effective in performing a complete dismantling process and then performing a sorting process according to the types of materials. The gardening shears of the disclosure is also conducive to the minimization of the difficulties in resources recycling, the required manpower and the incurred cost and the enhancement of recycling dealers’ incentive to recycle the gardening shears. The gardening shears of the disclosure can be effectively recycled and reproduced and thus can keep pace with the global trend toward net-zero carbon emissions and thus avoid flagging sales, boycotts, and a weak competitive position.

Second, the disclosure provides recyclable gardening shears with handles and pads made of the same material such that the pads can be easily peeled off the handles, complying with international recycling rules in force.

### BRIEF DESCRIPTION OF THE DRAWINGS

FIG. 1 is a perspective view of recyclable gardening shears of the disclosure.

FIG. 2 is an exploded view of the recyclable gardening shears of the disclosure.

FIG. 3 is a top view of the recyclable gardening shears of the disclosure.

FIG. 4 is a cross-sectional view of a handle and a leg coupled together according to the disclosure.

FIG. 5 is a cross-sectional view, from another angle, of the handle and the leg coupled together according to the disclosure.

FIG. 6 is a schematic view of the recyclable gardening shears of the disclosure, showing pads peeled off.

FIG. 7 is a schematic view of the recyclable gardening shears completely dismantled according to the disclosure.

FIG. 8 is a schematic view of the recyclable gardening shears sorting and recycling according to the disclosure.

### DETAILED DESCRIPTION

Objectives, features, and advantages of the disclosure are herein illustrated with specific embodiments, depicted with drawings, and described below.

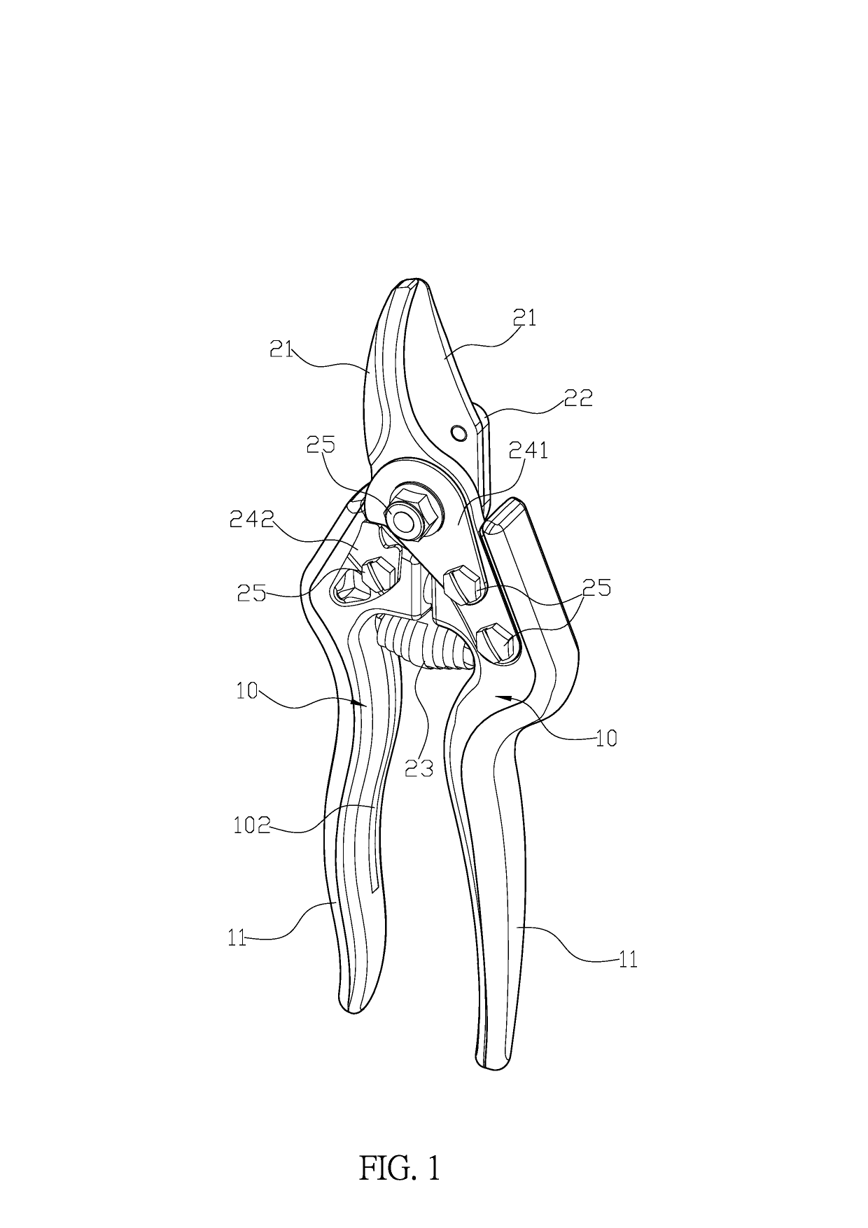

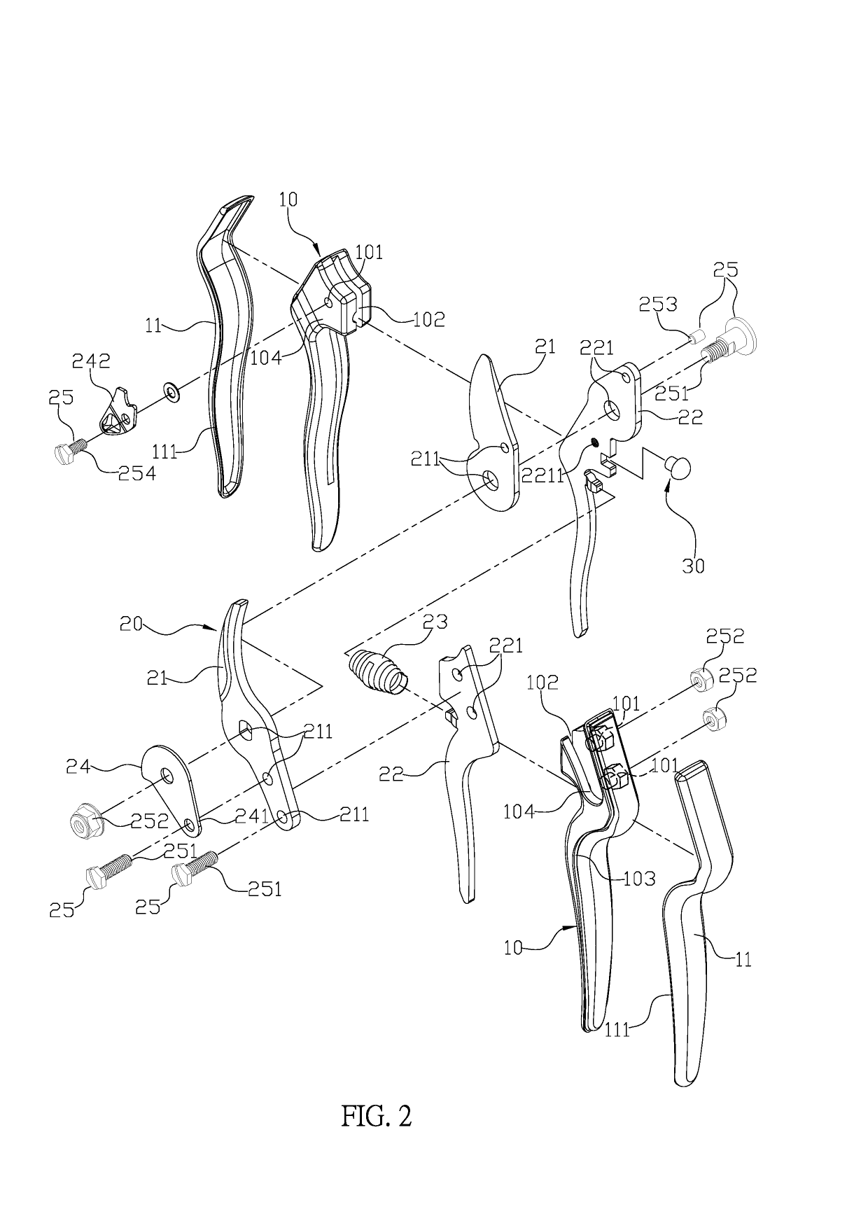

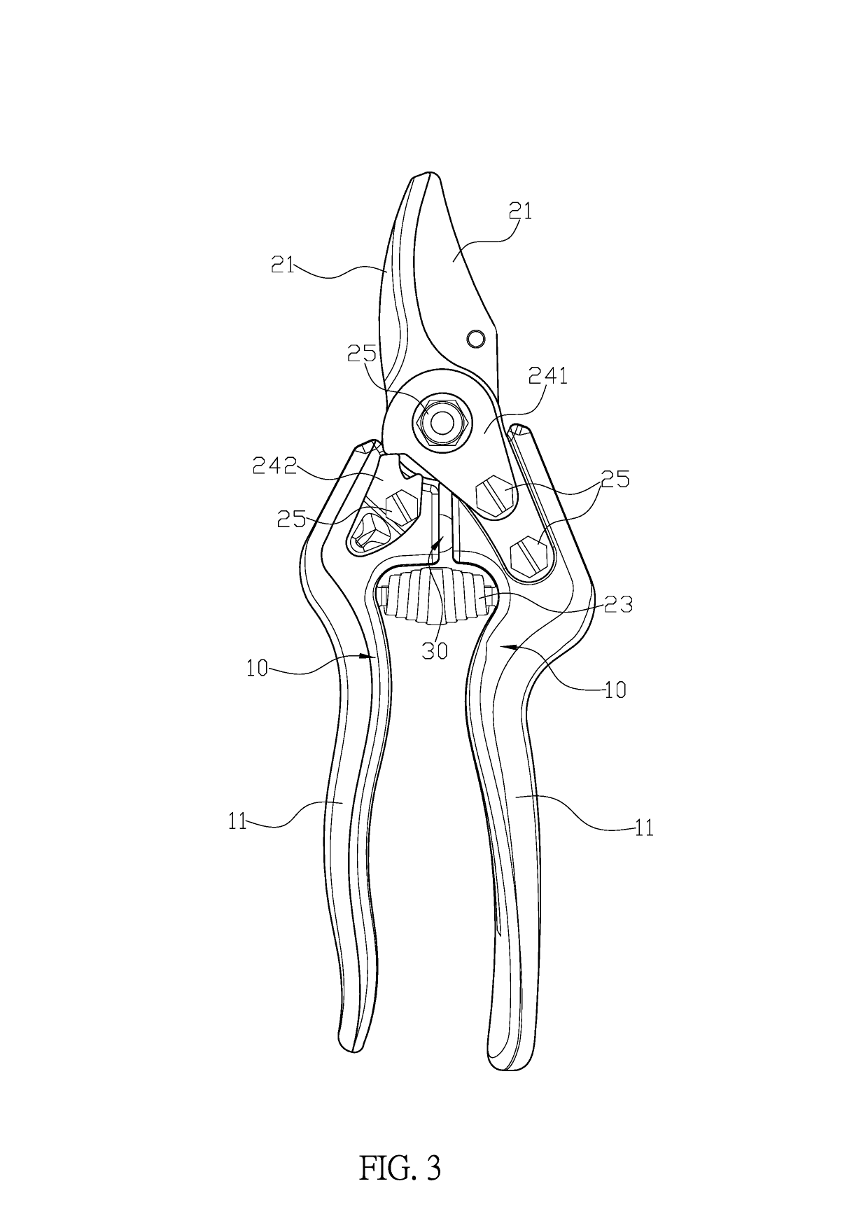

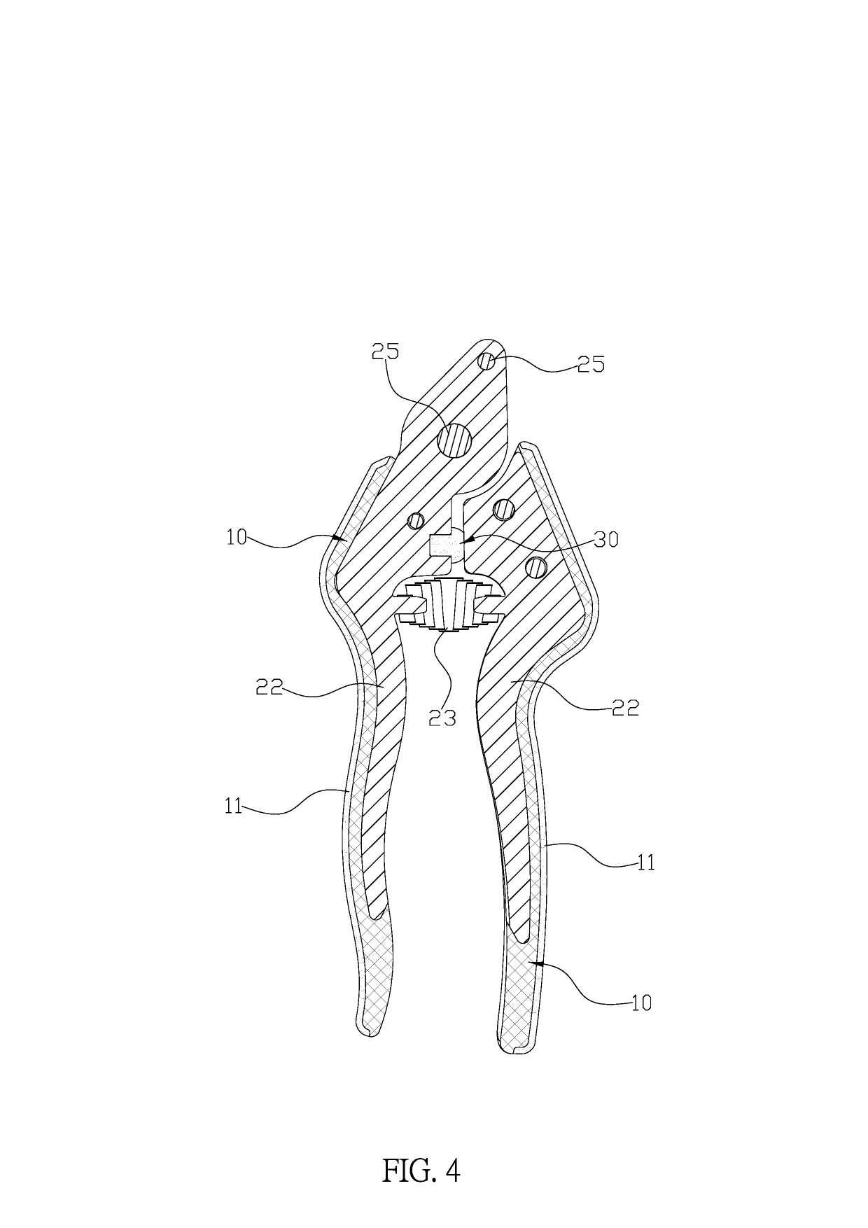

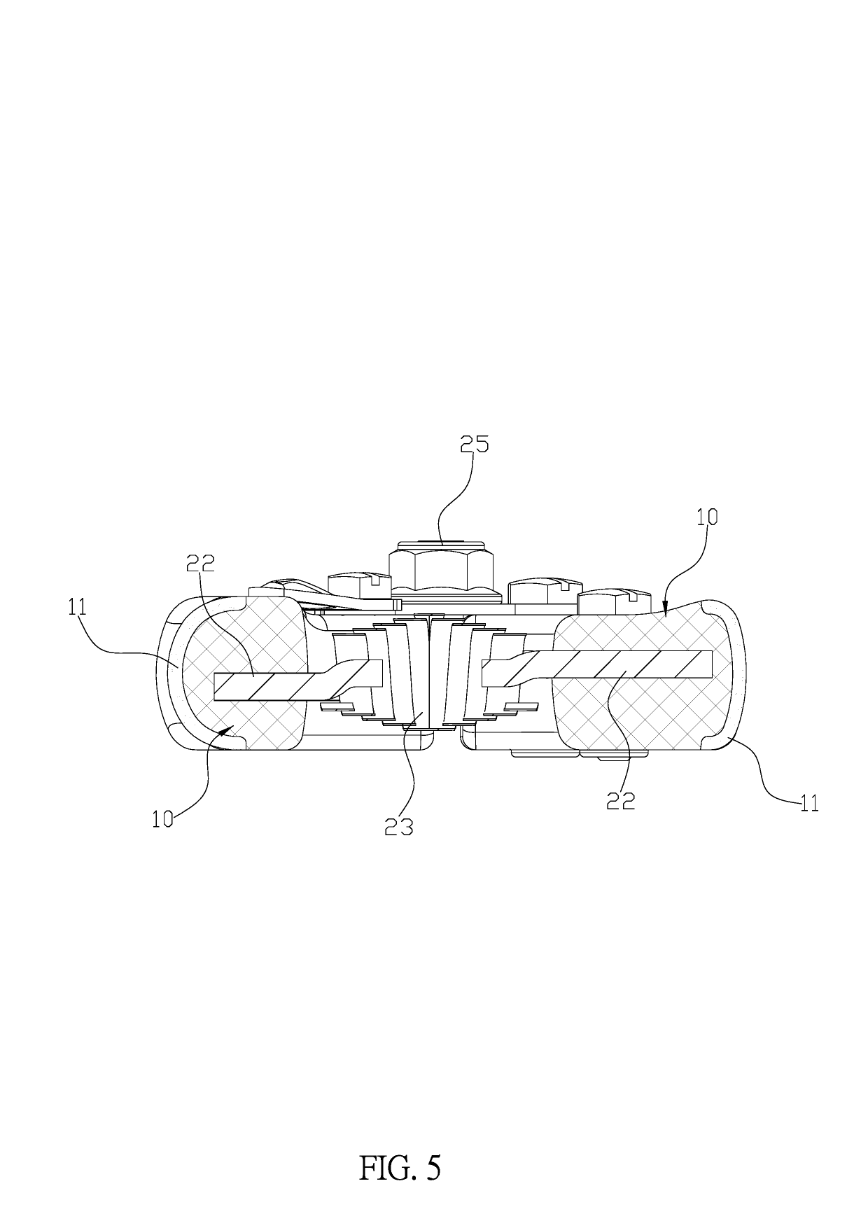

Referring to FIG. 1 through FIG. 5, the disclosure provides recyclable gardening shears comprising two handles (10) and a gardening shear body (20). The handles (10) are made of plastic. At least one through hole (101) is disposed on each of the handles (10). A slit (102) is disposed on one side of each of the handles (10) and extended to the top of the handle (10). The other side of the handle (10) is coupled to a pad (11) made of the same material as the handles (10). The gardening shear body (20) has metallic components, including two cutting elements (21), two legs (22), a resilient element (23), a safety device (24) and a plurality of joining elements (25). The two cutting elements (21) and the two legs (22) each have multiple penetrating holes (211)(221). The slits (102) of the two handles (10) engage with the two legs (22) respectively, and the joining elements (25) are penetratingly disposed in the through holes (101) and the penetrating holes (211)(221) respectively, allowing the handles (10) to be coupled to the legs (22), connecting the two cutting elements (21) pivotally, and connecting the legs (22) to the cutting elements (21). The safety device (24) is mounted on the handles (10) and the gardening shear body (20), using the joining elements (25). The resilient element (23) fits snugly between the two handles (10). A buffering pad (30) is fitted to one of the legs (22) and protrudes from the corresponding one of the handles (10).

The disclosure provides recyclable gardening shears, wherein the pads (11) are coupled to the handles (10) through buried injection.

The disclosure provides recyclable gardening shears, wherein the pads (11) in different colors are coupled to the handles (10).

The disclosure provides recyclable gardening shears, wherein the handles (10) each have a groove (103), and a rib (111) protrudes from the surface of one side of each of the pads (11), allowing the pads (11) to be firmly coupled to the handles (10) through the insertion of the ribs (111) into the grooves (103) respectively.

The disclosure provides recyclable gardening shears, wherein a depression portion (104) is disposed on the surface of one side of each of the handles (10), allowing an end segment of one of the cutting elements (21) to be inserted onto the depression portion (104) of one of the handles (10), and allowing the safety device (24) to be placed on the depression portion (104) of the other handle (10).

The disclosure provides recyclable gardening shears, wherein one of the cutting elements (21) is a blade, and the other cutting element (21) is an anvil.

The disclosure provides recyclable gardening shears, wherein the resilient element (23) is a barrel spring formed by winding a metal plate.

The disclosure provides recyclable gardening shears, wherein the resilient element (23) is a compression spring formed by winding a metal wire.

The disclosure provides recyclable gardening shears, wherein the safety device (24) has an engaging plate (241) and a blocking element (242), allowing the gardening shear body (20) to remain shut during an idle normal state upon installation of the safety device (24).

The disclosure provides recyclable gardening shears, wherein the joining elements (25) are a bolt (251) and a nut (252) fastened to each other.

The disclosure provides recyclable gardening shears, wherein one of the joining elements (25) is a latch (253).

The disclosure provides recyclable gardening shears, wherein one of the joining elements (25) is a screw (254), and one of the penetrating holes (221) of one of the legs (22) is a screw hole (2211) that the screw (254) is fastened to.

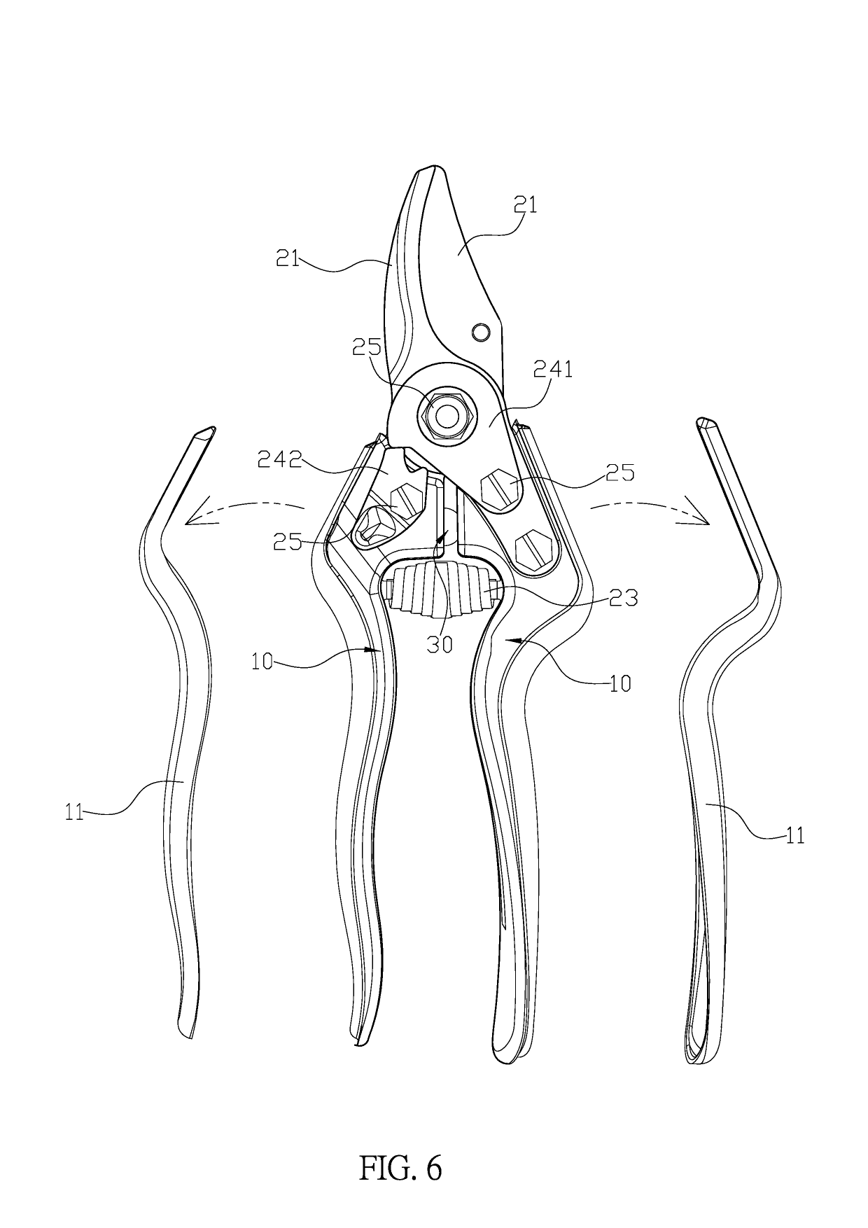

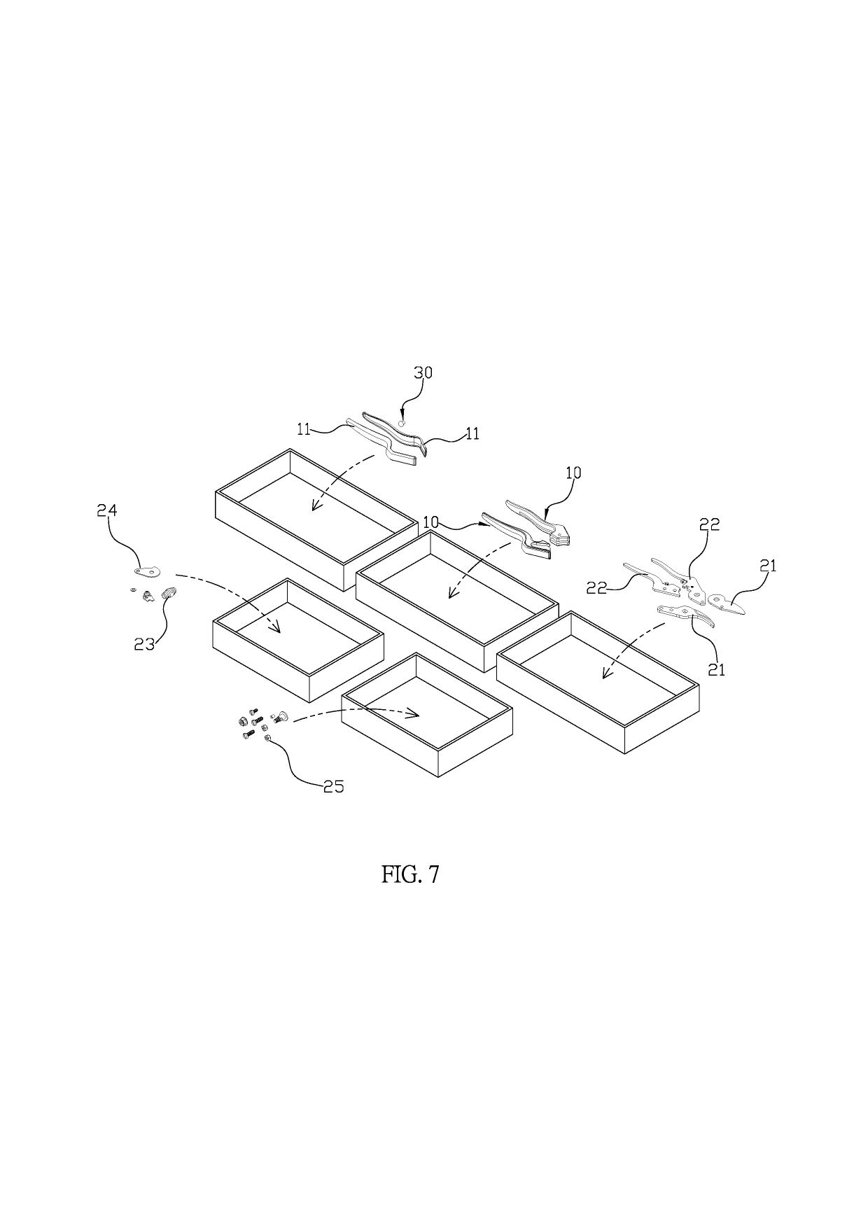

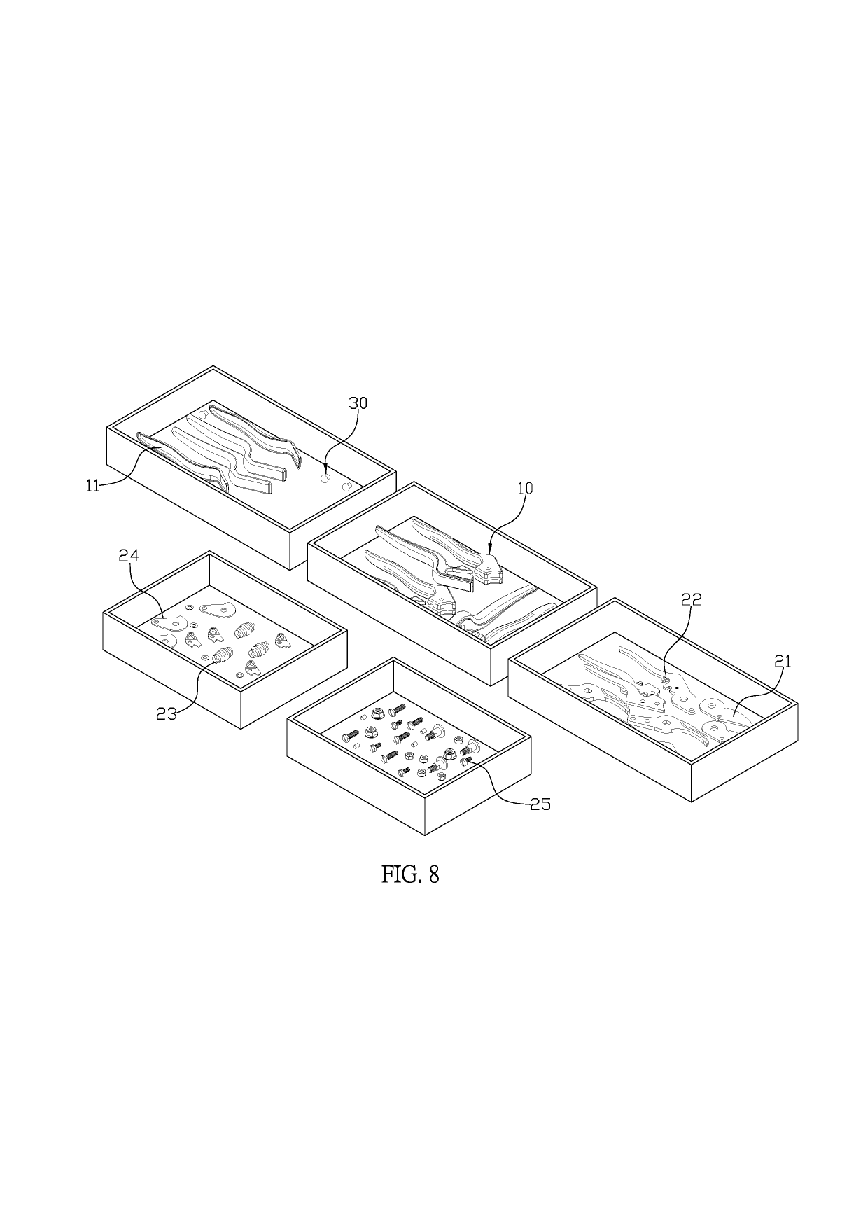

The recyclable gardening shears in the aforesaid specific embodiment of the disclosure has advantages described below. First, to recycle the gardening shears, a user only needs to peel the pads (11) off the handles (10) (as depicted by FIG. 6), detach the joining elements (25) and disengage the legs (22) from the slits (102), separating the handles (10), the pads (11), the cutting elements (21), the legs (22), the resilient element (23), the safety device (24), the joining elements (25) and the buffering pad (30). The gardening shears of the disclosure dispenses with a damaging means and is still effective in performing a complete dismantling process and then performing a sorting process according to the types of materials (as depicted by FIG. 7 and FIG. 8). The gardening shears of the disclosure is also conducive to the minimization of the difficulties in resources recycling, the required manpower and the incurred cost and the enhancement of recycling dealers’ incentive to recycle the gardening shears. The gardening shears of the disclosure can be effectively recycled and reproduced and thus can keep pace with the global trend toward net-zero carbon emissions and thus avoid flagging sales, boycotts, and a weak competitive position. Second, the handles (10) and the pads (11) are made of the same material such that the pads (11) can be easily peeled off the handles (10), complying with international recycling rules in force.

In conclusion, the disclosure provides radical innovation and thus improves on the prior art. In addition, the disclosure has high industrial applicability and involves an inventive step. Furthermore, the disclosure has never been published and has novelty.

The disclosure is disclosed above by a preferred embodiment. However, the embodiment shall not be interpreted as restrictive of the scope of the disclosure. Please note that all equivalent variations and modifications made to the embodiment according to the claims of the disclosure shall be deemed falling within the scope of the disclosure.

What is claimed is:

1. Recyclable gardening shears, comprising:
two handles; and
a gardening shear body,
wherein the handles are made of plastic, with at least one through hole disposed on each of the handles, a slit disposed on a side of each of the handles and extended to a top of the handle, and a pad made of same material as the handles and coupled to another side of the handle,
wherein the gardening shear body has two cutting elements, two legs, a resilient element, a safety device and a plurality of joining elements, made of metal each, with multiple penetrating holes disposed on each of the two cutting elements and each of the two legs, the slits of the two handles engage with the two legs respectively, and the joining elements are penetratingly disposed in the through holes and the penetrating holes respectively, allowing the handles to be coupled to the legs, connecting the two cutting elements pivotally, and connecting the legs to the cutting elements, wherein the safety device is mounted on the handles and the gardening shear body, using the joining elements, wherein the resilient element fits snugly between the two handles, wherein a buffering pad is fitted to one of the legs and protrudes from the corresponding one of the handles.

2. The recyclable gardening shears of claim 1, wherein the pads are coupled to the handles through buried injection.

3. The recyclable gardening shears of claim 1, wherein the pads in different colors are coupled to the handles.

4. The recyclable gardening shears of claim 1, wherein the handles each have a groove, and a rib protrudes from a surface of a side of each of the pads, allowing the pads to be firmly coupled to the handles through insertion of the ribs into the grooves respectively.

5. The recyclable gardening shears of claim 1, wherein a depression portion is disposed on a surface of a side of each of the handles.

6. The recyclable gardening shears of claim 1, wherein one of the cutting elements is a blade, and the other cutting element is an anvil.

7. The recyclable gardening shears of claim 1, wherein the resilient element is a barrel spring formed by winding a metal plate.

8. The recyclable gardening shears of claim 1, wherein the resilient element is a compression spring formed by winding a metal wire.

9. The recyclable gardening shears of claim 1, wherein the safety device has an engaging plate and a blocking element, allowing the gardening shear body to remain shut during an idle normal state upon installation of the safety device.

10. The recyclable gardening shears of claim 1, wherein the joining elements are a bolt and a nut fastened to each other.

11. The recyclable gardening shears of claim 1, wherein one of the joining elements is a latch.

12. The recyclable gardening shears of claim 1, wherein one of the joining elements is a screw, and one of the penetrating holes of one of the legs is a screw hole that the screw is fastened to.
